(19) United States
(12) Patent Application Publication
(10) Pub. No.: US 2007/0118529 A1
(43) Pub. Date: May 24, 2007

(54) Content download experience

(76) Inventors: James A. Howell JR., Georgetown, TX (US); Shannon C. Boesch, Austin, TX (US)

Correspondence Address: HAMILTON & TERRILE, LLP, P.O. BOX 203518, AUSTIN, TX, 78720, US

(21) Appl. No.: 11/282,181

(22) Filed: Nov. 18, 2005

(51) Int. Cl. G06F 17/30

(52) U.S. Cl. 707/10

(57) ABSTRACT

A method of improving a content download experience for an information handling system is disclosed. The method includes storing content locally onto the storage of an information handling system when the information handling system is manufactured and checking the locally stored content prior to attempting to download content when accessing the content.

### BACKGROUND OF THE INVENTION

1. Field of the Invention

The present invention relates to build to order systems, and more particularly, to improving the content download experience for build to order systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide a customer with an ability to configure and order an information handling system via an on-line store. The on-line store includes a configurator that allows the customer to customize and procure the system on-line. The configurator allows the customer to select a given system model and to customize the system according to the user selected options.

After a system is configured, the customer may be provided the opportunity to order particular software, services or content. When the customer indicates a desire to order such software, services or content, the customer can order the software services content via the on-line store.

Additionally, it is known to provide built to order information handling systems with links to online portals that enable customers to download content such as music, movies and additional software titles (such as for example game applications) to their systems.

The compelling content that customers desire changes frequently and therefore is often stored and managed online to prevent inefficient changes to the software that is installed during the manufacture of the build to order system, via, e.g., a software stack. By providing this content online the first time that a customer attempts to purchase and consume the content via a manufacturer content channel, the customer must wait for the initial desired content to be downloaded. This can result in a relatively long download delay (e.g., up to 1 hour for 100 Mbytes of content for a dialup connection). Even with broadband connections, the time to download content can be a significant barrier to customer acceptance of the content channel.

What is needed is a way to leverage a build to order environment to improve the initial experience of customers purchasing content.

### SUMMARY OF THE INVENTION

In accordance with the present invention, the invention relates to a method of improving a content download experience for an information handling system. The method includes storing content locally onto the storage of an information handling system when the information handling system is manufactured and checking the locally stored content prior to attempting to download content when accessing the content.

In another embodiment, the invention relates to an apparatus of improving a content download experience for an information handling system which includes means for storing content locally onto the storage of an information handling system when the information handling system is manufactured and means for checking to locally stored content prior to attempting to download content when accessing the content.

In another embodiment, the invention relates to a system of improving a content download experience for an information handling system. The system includes a content store module and a content portal application. The content store module stores content locally onto the storage of an information handling system when the information handling system is manufactured. Prior to attempting to download content when accessing the content, the content portal application checks the locally stored content.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows an example of an automated build to order system for installing software on an information handling system.

FIG. 3 shows access to the on-line store and a content channel via the Internet using a computer system.

FIG. 4 shows a system block diagram of an information handling system.

FIG. 5 shows a block diagram of a system for providing improved content download experience is shown.

FIG. 6 shows a flow chart of the operation of a system for providing improved content download experience is shown.

### DETAILED DESCRIPTION

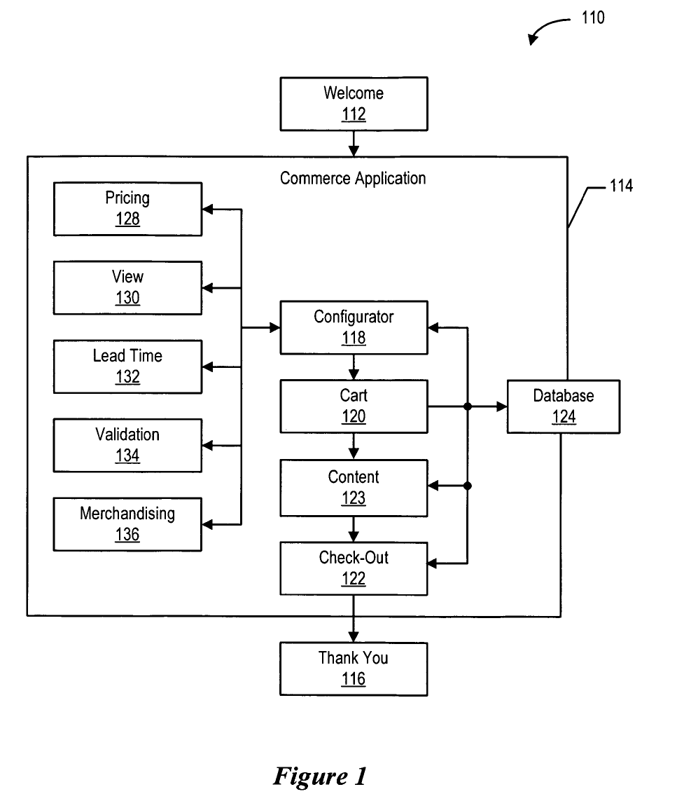

Referring to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122 and content module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and content module 123 are all linked to the database 124.

In operation of the on-line store 110, the welcome module 112 presents a welcome page 112, the configurator I 18 presents a configurator page, the shopping cart 120 presents a shopping cart page, the checkout module 122 presents a checkout page, the content module 123 presents a content selection page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, a customer is transferred to a content page in which the customer is provided an opportunity to select various content such as music, video streaming, training or games to have installed onto the system. After completion of the content module 123, the customer is transferred to a checkout page. After completion of the checkout, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and content module 123 are each part of the commerce application 114 and interact with the database 124. For example, with the shopping cart 120, additional merchandising information associated with a particular system which has been configured and placed in the shopping cart by an on-line store customer can be provided.

Also for example, various content may be provided for order by the customer by the content module 123 based upon the type of system ordered as well as components that are included within the system ordered. Additionally, by providing the content module within the commerce application 114, the customer continues the experience a similar customer experience and the system provider is able to use the information from the database 124 and to maintain control over the customer contact. By maintaining control over the customer contact the system provider is able to determine what content is selected and to maintain accurate and up to date records of the selected content.

Additionally, the content module 123 can provide a customer with an option of how much content to preload onto the information handling system during the manufacture of the information handling system.

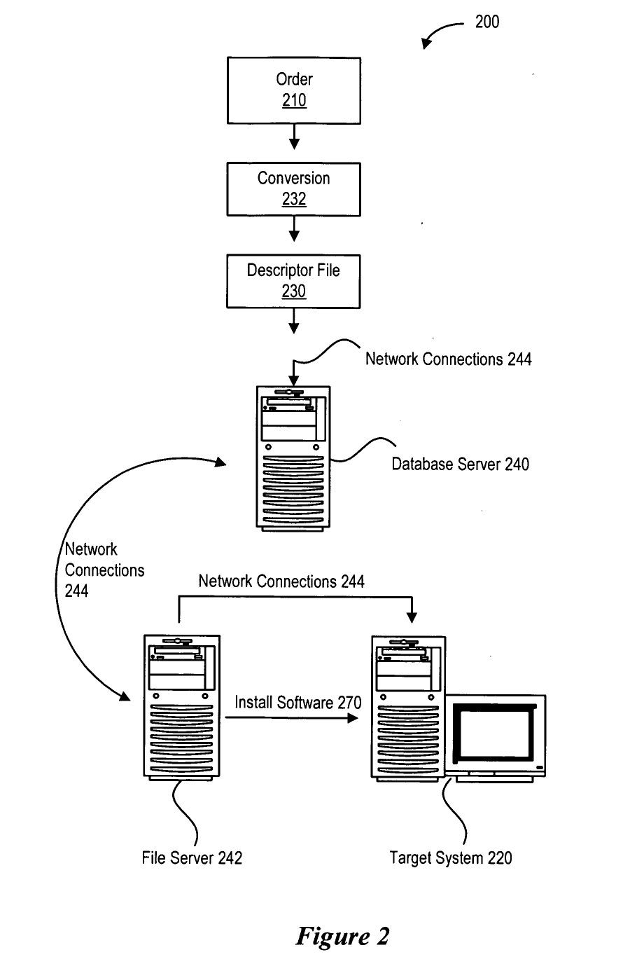

Referring to FIG. 2, a schematic diagram of a software installation system 200 at an information handling system manufacturing site is shown. In operation, an order 210 is placed to purchase a target information handling system 220. The target information handling system 220 to be manufactured contains a plurality of hardware and software components. For instance, target information handling system 220 might include a certain brand of hard drive, a particular type of monitor, a certain brand of processor, and software. The software includes a particular version of an operating system along with all appropriate driver software and other application software along with appropriate software bug fixes. The software also includes ordered content as well as any additional local content to be installed by the manufacturer.

Before target information handling system 120 is shipped to the customer, the plurality of components are installed and tested from, for example, a fixed image of the software. Such software installation and testing advantageously ensures a reliable, working information handling system which is ready to operate when received by a customer.

Because different families of information handling systems and different individual computer components require different software installation, it is necessary to determine which software to install on a target information handling system 220. A descriptor file 230 is provided by converting an order 210, which corresponds to a desired information handling system having desired components, into a computer readable format via conversion module 232. The descriptor file 230 can also include which content to load on the system.

Component descriptors are computer readable descriptions of the components of target information handling system 220 which components are defined by the order 210. In a preferred embodiment, the component descriptors are included in a descriptor file called a system descriptor record which is a computer readable file containing a listing of the components, both hardware and software, to be installed onto target information handling system 220. Having read the plurality of component descriptors, database server 240 provides a plurality of software components corresponding to the component descriptors to file server 242 over network connection 244. Network connections 244 may be any network connection well-known in the art, such as a local area network, an intranet, or the internet. The information contained in database server 240 is often updated such that the database contains a new factory build environment. The software is then installed on the target information handling system 220. The software installation is controlled by a software installation management server that is operable to control the installation of the operating system and other software packages specified by a customer.

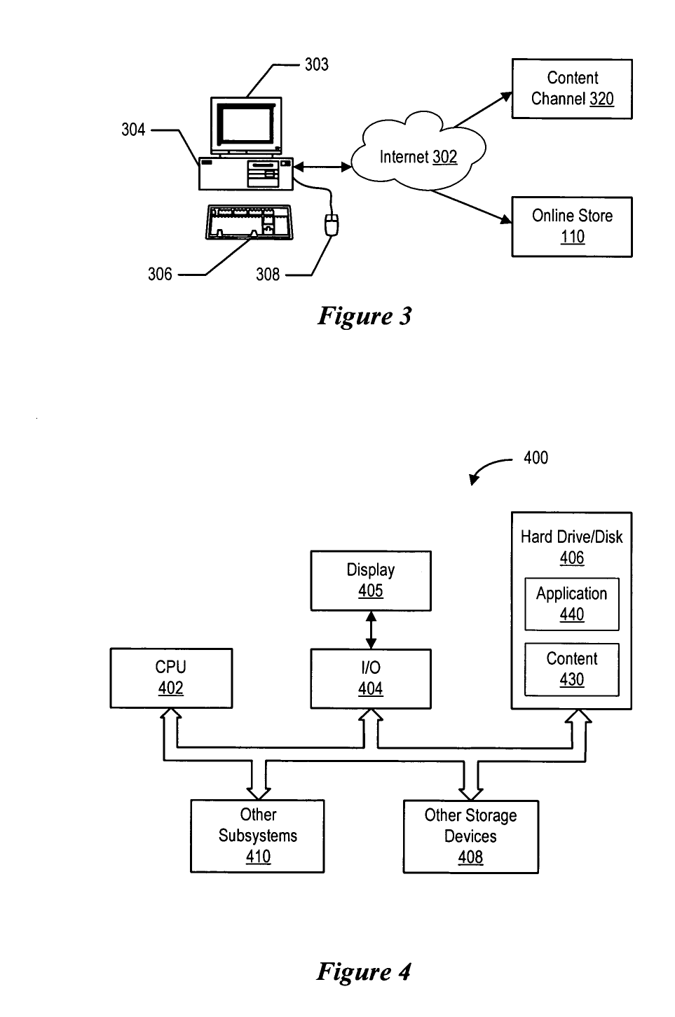

Referring to FIG. 3, a customer can access the on-line store 110 using any suitable computer equipment 300, via the Internet 302. The computer equipment 140 may include a display 203, computer 204, keyboard 206, and pointing device 208. Display 203 is used for displaying the various pages of the on-line store while a customer is using the on-line store. Also, the computer equipment 300 can also access a content channel 320 such as a manufacturer content channel via the Internet 302.

Referring briefly to FIG. 4, a system block diagram of an information handling system 400 is shown having features thereof configured in accordance with the on-line store 110. The information handling system 400 includes a processor 402, input/output (I/O) devices 404, such as a display, a keyboard, a mouse, and associated controllers, a hard disk and drive 406, and other storage devices 408, such as a floppy disk and drive and other memory devices, and various other subsystems 410, all interconnected via one or more buses 412. The information handling system 400 also includes local content 430 and a content portal application 440 that accesses the content 430 stored on the non-volatile memory For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

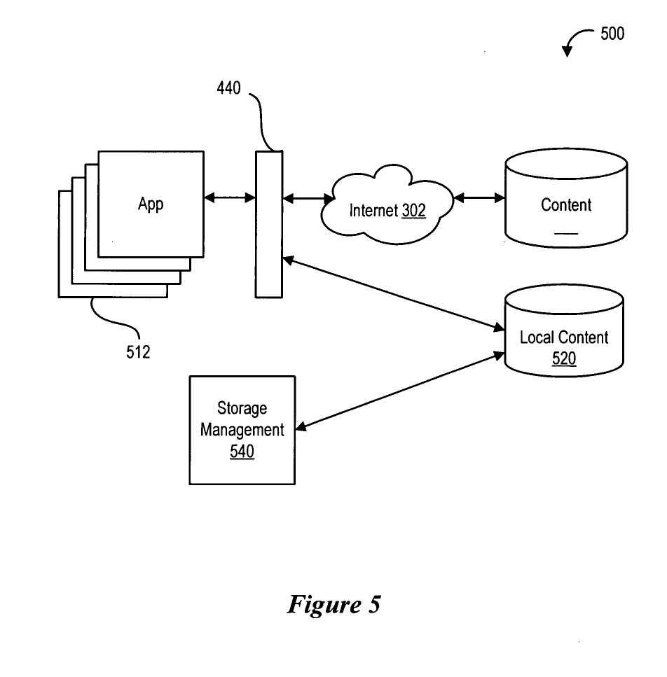

Referring to FIG. 5, a block diagram of a system 500 for providing improved content download experience is shown. More specifically, the system 500 includes a content portal application 440 which interacts with a plurality of applications 512 that access content. The content portal application 440 accesses local content storage 520. If the content is not present in the local content storage 520, then the content portal seamlessly accesses on-line content 530 via the Internet 202.

The local content storage 520 is stored in a standard location within the hard driver 306 that contains optional content that can be included when new information handling systems are fabricated.

The system also includes a storage management module 540. The storage management module 540 interacts with the local content and monitors how much available storage space is left within the non-volatile storage (e.g., the hard drive). When the non-volatile storage starts running out of free hard drive space, the storage management module 540 starts removing or deleting some or all of the local content that is stored within the local content storage 520.

The storage management module 540 can also be set to remove certain types of content. For example, the storage management module 540 might be configured to only remove training content, while leaving locally stored movies.

The content portal application 440 first checks the local content storage 520 before attempting to locate and download the same content over the Internet 202.

The content portal application 440 informs customers of expected download times for content such as movies, games and other software titles will modify the expected download times based on the availability of content in the local content storage 520. For example, movies in the local content storage 520 might require a five second download while moves not in the cache might require a five hour download.

The factory installed local content storage 520 can be updated regularly based on real world customer usage to better align with customer's content download tendencies.

This system provides advantages of both local and online delivery methods. Because all content is available online, the available and promoted content can be frequently refreshed even as a large variety of content is made available. A build to order environment is then applied to improve the customer experience of promoted content which is cached locally on the information systems. An improved customer experience thus results in more customers trying and purchasing more content via the manufacturer channel. When content customers have been created via a positive experience of an initial trial or purchase of content, additional content can be downloaded which has industry standard download times.

Thus, the system provides an optional content caching model that is enhanced by updating digital content within the factory and providing customers with a more cohesive experience when purchasing an information handling system. Because the customer has a positive experience during an initial number of content accesses, odds are increased that the customer will continue to access content via the manufacturer content channel. The information handling system thus becomes an entertainment hub within the customer's home.

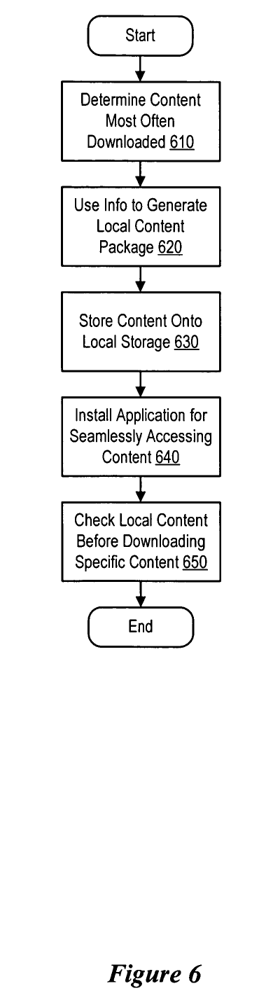

Referring to FIG. 6, a flow chart of the operation of a system for providing improved content download experience is shown. More specifically, the system for providing improved content download experience 600 determines the content that is most often downloaded such as content that is downloaded from the manufacturer content channel 320 at step 610. Thus, the determining might determine a top ten lost of the most frequently downloaded songs, games or movies. The applications 512 can be configured to display this list when the applications are first actuated.

Next, the system 600 uses this information to generate a local content package at step 620. Next, the system 600 stores the local content package into the local content storage 520 at step 630. If the factory is running behind schedule when configuring information handling systems, then the local content may optionally not be stored onto local content storage 520. Thus, the amount of content stored locally may be configurable based upon factory bandwidth. Thus the system fails gracefully because the content is still available online.

Because the storing of the content is automated, the cost to the manufacturing to store the content is similar whether a small amount of content is stored locally (e.g., a few songs or a single movie), or a large amount of content is stored locally (e.g., 1000 songs or 100 movies).

Next, the system 600 installs an application (e.g., the content portal application 440) for seamlessly accessing content which is either locally stored or accessible online at step 640.

After the information handling system is provided to the customer, as indicated by dashed line 650, when the customer accesses an application 512 for which content is desired, the system 600 checks the local content before downloading specific content from an online content source. If the content is stored within the local content, then the application 512 uses the local content. Thus, the customer is provided with an improved content download experience as the access to the locally stored content is faster as compared to downloading the content from an online source. The application can be configured to highlight or otherwise note that the locally stored content to encourage the customer to access this content first.

### Other Embodiments

Other embodiments are within the following claims.

For example, the configurator which interacts with the database 124 may be used by a telephone sales person when a system is being ordered via the telephone. By maintaining control over the customer contact the system provider is able to determine what content is ordered and to maintain accurate and up to date records of the service activation.

Also for example, while specific types of content are identified, other content may also be selected by the content module.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method of improving a content download experience for an information handling system comprising:
storing content locally onto storage of an information handling system when the information handling system is manufactured; and
checking to locally stored content prior to attempting to download content when accessing the content.

2. The method of claim 1 wherein
the checking the locally stored content is via a content portal application.

3. The method of claim 1 wherein
the checking is seamless to a user of the information handling system.

4. The method of claim 1 further comprising
determining which content is most often downloaded; and
storing content locally based upon the determining.

5. The method of claim 1 further comprising
regularly determining which content is most often downloaded; and,
updating which content is stored locally based upon the regularly determining.

6. The method of claim 1 wherein
the content includes at least one of music content, video content, training content and game application content.

7. The method of claim 1 further comprising
configuring an information handling system to include components; and
storing content locally based upon the components selected during the configuring.

8. An apparatus of improving a content download experience for an information handling system comprising:
means for storing content locally onto storage of an information handling system when the information handling system is manufactured; and
means for checking to locally stored content prior to attempting to download content when accessing the content.

9. The apparatus of claim 8 wherein
the checking the locally stored content is via a content portal application.

10. The apparatus of claim 8 wherein
the checking is seamless to a user of the information handling system.

11. The apparatus of claim 8 further comprising
determining which content is most often downloaded; and
storing content locally based upon the determining.

12. The apparatus of claim 8 further comprising
means for regularly determining which content is most often downloaded; and,
means for updating which content is stored locally based upon the regularly determining.

13. The apparatus of claim 8 wherein
the content includes at least one of music content, video content, training content and game application content.

14. The apparatus of claim 8 further comprising
means for configuring an information handling system to include components; and
means for storing content locally based upon the components selected during the configuring.

15. A system of improving a content download experience for an information handling system comprising:
a content store module, the content store module storing content locally onto storage of an information handling system when the information handling system is manufactured; and
a content portal application, the content portal application checking to locally stored content prior to attempting to download content when accessing the content.

16. The system of claim 15 wherein
the checking is seamless to a user of the information handling system.

17. The system of claim 15 further comprising
a content determination module, the content determination module determining which content is most often downloaded; and wherein
the content store module stores content locally based upon the determining.

18. The system of claim 15 further comprising
a content determination module, the content determination module regularly determining which content is most often downloaded; and wherein
the content store module updates which content is stored locally based upon the regularly determining.

19. The system of claim 15 wherein
the content includes at least one of music content, video content, training content and game application content.

20. The system of claim 15 further comprising
a configuring module, the configuring module configuring an information handling system to include components; and wherein
the content store module stores content locally based upon the components selected during the configuring.
